(19) United States
(12) Patent Application Publication
(10) Pub. No.: US 2002/0090081 A1
(43) Pub. Date: Jul. 11, 2002

(54) Electronic device with keyboard

(76) Inventor: Takuo Kitamura, Gifu (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/792,897

(22) Filed: Feb. 26, 2001

(30) Foreign Application Priority Data
Jan. 11, 2001 (JP) 2001-003702

(51) Int. Cl. H04M 1/00; H04M 3/00

(52) U.S. Cl. 379/433.07; 379/368

(57) ABSTRACT

An improved alphabet entry method is provided in which several particular keys are added to provide favorable operability when a sentence is entered with selection of an entry word candidate from a plurality of possible letter strings based on typing through a search of a word dictionary. Each of some of data keys (132 to 139) is assigned a plurality of letters of the alphabet, and each of some of the other data keys (131, 141) and some of control keys (117, 119, 120, and 122) is assigned only one of particular letters (A, S, U, E, I, and O) of the plurality of letters assigned to the some of the data keys simultaneously with the assignment to the some keys. Since an operator performs entry with the keys assigned only the particular letters to determine some letters in a letter string to be entered, candidates for a word are narrowed down to allow efficient word entry.

### BACKGROUND OF THE INVENTION

1. Field of the Invention

The present invention relates to an electronic device with a keyboard for entering letters of the alphabet to an electronic device, and more particularly to an alphabet entry method in which selected candidates for words to be entered are used to constitute a sentence to be entered and each entry word candidate is selected through a search of a word dictionary from a plurality of strings formed by combining letters of the alphabet typed on a keyboard.

2. Description of the Related Art

When a keyboard is used to enter letters of the alphabet in a portable electronic device, for example a cellular phone, a keyboard including approximately 10 keys for numerical entry is used to perform entry of 26 letters of the alphabet. In this case, it is necessary to assign a plurality of letters of the alphabet to one key for entry of the alphabet. FIG. 1 is a schematic view showing an example of the placement of keys and the assignment of the letters of the alphabet to the keys on a keyboard of a conventional cellular phone. Keyboard 600 comprises control key section 610 and data key section 630 in which data key section 630 comprises 10 numerical keys and two symbol keys. The letters of the alphabet are assigned to the numerical keys, and numbers or the letters of the alphabet are entered by switching between entry modes. Description is hereinafter made for a method of entering an English word by an operator through the use of the keyboard. Three or four letters of the alphabet are assigned to each of numerical keys 632 to 639. When an operator presses these keys for entry, the cellular phone needs to identify which letter of the alphabet is an entry target since a plurality of letters of the alphabet are assigned to the same key. For example, when the operator attempts to enter “AID”, the operator presses numerical key 632, numerical key 634, and numerical key 633 in this order, to which the respective letters are assigned, and then presses symbol key 642 serving as a space key. Since each of numerical key 632, numerical key 634, and numerical key 633 is assigned three letters of the alphabet, 27 possible combinations of letters of the alphabet exist. FIG. 2 is a list which shows the combinations of the letters of the alphabet when numerical keys 632, 634, and 633 are pressed in this order. Of these 27 combinations, however, only three words “AGE”, “AID”, and “BID” surrounded by boxes in FIG. 2 have meanings as English words. Thus, the three combinations are candidates for entry. One of the entry candidates, “AGE”, is first displayed on a display screen, not shown. Since the operator does not attempt to enter “AGE”, the operator presses numerical key 631 to which a next candidate selecting function is assigned, for example. Then, “AID” is displayed as the next entry candidate. Since “AID” is the word intended by the operator, the operator then presses symbol key 642 serving as a space key to confirm the entry of “AID”.

Since the limited number of combinations of letters of the alphabet make sense as English words in general, entry candidates are narrowed down from the 27 possible combinations to three in this example. A cellular phone is provided with a word dictionary which is used to search combinations of letters of the alphabet making sense as English words of the 27 possible combinations resulting from the pressing of numerical key 622, numerical key 624, and numerical key 623 in this order, thereby allowing the candidates to be narrowed down from 27 to the aforementioned three words. In this manner, a letter of the alphabet to be entered can be identified when the keyboard on which one key is assigned a plurality of letters is used.

In the prior art method, even when word candidates are narrowed down from many combinations of letters of the alphabet to fewer combinations as shown in FIG. 2 through a comparison with the word dictionary, a plurality of words remain as candidates. When a plurality of candidates exist, a desired word need be selected from the plurality of candidates to cause a problem of the need for associated typing by an operator. The typing disturbs the original rhythm of keying to cause another problem of reduced efficiency of the keying. Thus, it is desirable to reduce the number of the word candidates, preferably to one. In addition, words stored in the aforementioned dictionary typically include no proper nouns or trade names, and in such a case, it is desirable to allow entry of proper nouns or the like in a relatively simple and exceptional manner.

### SUMMARY OF THE INVENTION

It is an object of the present invention to provide an improved alphabet entry method which provides favorable operability, allows exceptional entry, and facilitates check of entered results, by adding several particular keys to a conventionally standard key array in alphabetical order as shown in FIG. 1 for entering a sentence with selection of an entry word candidate from a plurality of possible strings based on typing through a search of a word dictionary.

The present invention provides an electronic device with a keyboard including keys for entering letters of the alphabet, wherein the keyboard comprises data keys for entering numbers, letters of the alphabet and symbols, and control keys for entering operation signals. Each of some keys of the data keys is assigned a plurality of letters of the alphabet, and each of some keys of the other data keys and some keys of the control keys is assigned only one of particular letters of the plurality of letters of the alphabet assigned to the some keys simultaneously with the assignment to the some keys. A plurality of letters of the alphabet are assigned to each key of the some keys of the data keys such that letters of the alphabet are regularly arranged in alphabetical order on the some keys.

The particular letters of the alphabet may be A, I, U, E, and O which are letters for vowels. The particular letters of the alphabet may also include a letter S.

Preferably, the electronic device comprises a word dictionary, and all letters of the alphabet assigned to a pressed key are candidates for entry, letter strings formed by combining all letters in pressing order are listed, all the listed letter strings are compared with words stored in the dictionary, a word matching any of the listed letter strings is extracted and serves as a candidate for a word, and an operator selects and determines for entry a desired word from the candidates for a word.

The particular letters of the alphabet may be entered by pressing the keys assigned only the particular letters and by pressing the keys assigned the particular letters as one of the plurality of assigned letters. Alternatively, the particular letters of the alphabet may be entered only by pressing the keys assigned only the particular letters of the alphabet.

The extracted candidate for a word is displayed in a temporary entry area on a display screen of the electronic device, and an operator may select a desired word as a determined word and may move the selected word to a sentence entry area on the display screen. The letters of the alphabet displayed in the sentence entry area are preferably smaller than the letters displayed in the temporary entry area.

An operator may select a letter of the alphabet in a letter string displayed in the temporary entry area through the use of a cursor key, and may change the letter to another letter through a predetermined key operation to obtain a desired determined word.

As described above, in the electronic device comprising a keyboard according to the present invention, since frequently used letters are assigned individually to the keys including some of the control keys, letters entered through these keys are determined immediately. Thus, the number of candidates for a word can be reduced to enhance the efficiency of alphabet entry.

Since the keys are added as long as conditions permit and the added keys are shared with other purposes, the keys assigned particular letters individually can be provided by adding a small number of the keys. Therefore, the present invention is effectively applied especially to a device which requires the number of physical keys to be minimized such as a cellular phone.

In addition, the present invention enables an operation compatible with that of a conventionally used standard keyboard with keys of alphabetical arrangement, which allows an operator to also use a familiar key operation as required, thereby enhancing the efficiency of alphabet entry.

Since an operator can change an arbitrary letter to another letter in the letter string displayed in the temporary entry area on the display screen by moving the cursor and pressing a next candidate selecting key, the temporarily entered letter string is modified with a relatively simple operation. As a result, an arbitrary letter string including a proper noun absent in the word dictionary can be determined as entry to enter a sentence.

Furthermore, an operator sufficiently checks the letter string which is temporarily entered in visible form before the string is moved to the sentence entry area in which the letters are displayed in a smaller size. It is thus possible to make sentence entry with many sentences displayed on the limited display screen without reducing operability.

The above and other objects, features, and advantages of the present invention will become apparent from the following description based on the accompanying drawings which illustrate an example of a preferred embodiment of the present invention.

### BRIEF DESCRIPTION OF THE DRAWINGS

FIG. 1 is a schematic view showing an example of placement of keys and assignment of letters of the alphabet to the keys on a keyboard of a conventional cellular phone;

FIG. 2 is a list showing combinations of letters of the alphabet when numerical keys 632, 634, and 633 in FIG. 1 are pressed in this order;

FIG. 3 shows placement of keys on a keyboard of a cellular phone according to an embodiment of the present invention;

FIG. 4 is a schematic view showing a display screen of the cellular phone on which a sentence is entered;

FIG. 5 and FIG. 6 are schematic views showing a key entry area and a temporary entry area on the display screen, respectively; and

FIG. 7 is a schematic view showing an example of placement of keys and display of letters of the alphabet on a keyboard in a non-compatible mode of the present invention.

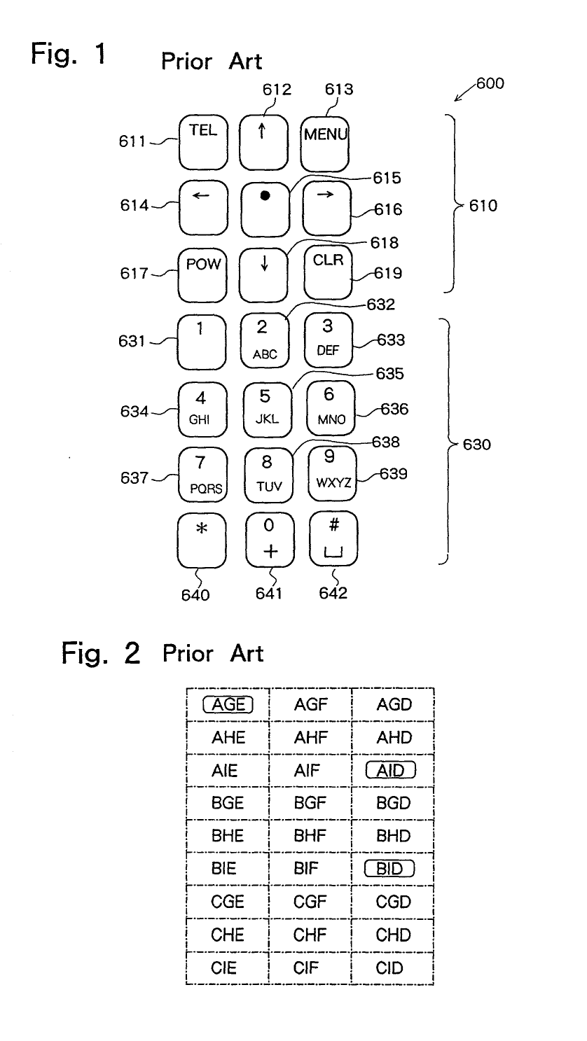

### DETAILED DESCRIPTION OF THE PREFERRED EMBODIMENT

Next, an example of the present invention is described with reference to the drawings. In an electronic device with a keyboard according to the present invention, a word is determined on the basis of letters of the alphabet entered by pressing keys on a keyboard, and is used by the CPU of the electronic device such as a cellular phone, not shown, for a predetermined purpose.

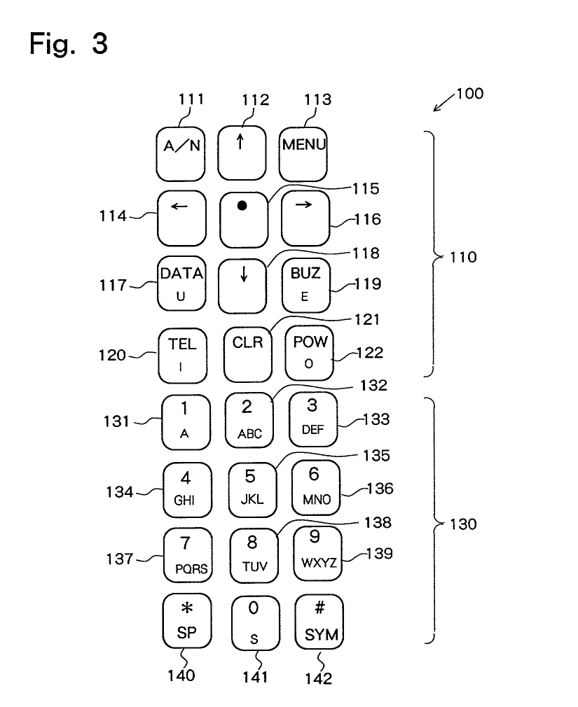

Referring to FIG. 3, there is shown keyboard 100 of a cellular phone according to an embodiment of the present invention which comprises control key section 110 and data key section 130. Keys in control key section 110 comprise A/N key 111, ↑key 112, MENU key 113, ←key 114, ●key 115, →key 116, DATA key 117, ↓key 118, BUZ key 119, TEL key 120, CLR key 121, and POW key 122. DATA key 117 is assigned a letter U of the alphabet; BUZ key 119, a letter E; TEL key 120, a letter I; and POW key 122, a letter O.

Numerical keys 131 to 139 and 141 in data key section 130 are assigned numbers 1 to 9 and 0, respectively; symbol key 140, a symbol *; and symbol key 142, a symbol #. In addition, numerical key 131 is assigned a letter A; numerical key 132, letters A B, and C; numerical key 133, letters D, E, and F; numerical key 134, letters G, H, and I; numerical key 135, letters J, K, and L; numerical key 136, letters M, N, and O; numerical key 137, letters P, Q, R, and S; numerical key 138, letters T, U, and V; numerical key 139, letters W, X, Y, and Z; and numerical key 141, a letter S.

DATA key 117, BUZ key 119, TEL key 120, and POW key 122 are used as a switching key to a data processing mode, a silencing mode designating key, a switching key to telephone, and a power on/off key, respectively, of control keys in a telephone function of the cellular phone. In the data processing mode, however, the keys are used as keys for entering letters U, E, I, and O assigned thereto, respectively.

Similarly, each numerical key is used as a key for entering each letter assigned thereto when entry of letters of the alphabet is selected in the data processing mode, or used as a key for entering each number assigned thereto when numerical entry is selected.

It should be noted that the type and the placement of the keys in FIG. 3 are illustrative. It is essential only that, for some of the data keys, each key is assigned a plurality of letters of the alphabet, and for some of the other data keys and some of the control keys, each key is assigned only one of particular letters of the plurality of letters assigned to the some data keys simultaneously with the assignment to the some data keys.

Next, description is made for entry operations of letters of the alphabet, numbers, and symbols to enter a sentence using these keys. Pressing and holding POW key 122 for one second or longer turns the power of the cellular phone on. In this state, the device operates as a telephone. When DATA key 117 is pressed, the device enters into the data processing mode for performing data processing. Pressing of MENU key 113 causes a data processing function menu to be displayed on a display screen, not shown, in which a sentence entry function, one of the functions in the menu, is selected through the use of arrow key 114 or the like. In this state, an operator can enter letters of the alphabet, number, and symbols to edit and enter a sentence.

A/N key 111 serves a key for mode switching between numerical entry and alphabet entry. In the numerical entry mode, the operator can use from numerical key 131 to numerical key 139 and numerical key 141 to enter numbers.

The alphabet entry mode includes a compatible mode and a non-compatible mode. The compatible mode is first described. The compatible mode includes three entry methods. In a first entry method, the operator can enter letters of the alphabet by using DATA key 117, BUZ key 119, TEL key 120, POW key 122, numerical keys 131 to 139, and numerical key 141 as data keys. When numerical key 131, TEL key 120, DATA key 117, BUZ key 119, or POW key 122 is pressed, the letter A, I, U, E, or O is entered. When numerical key 141 is pressed, the letter S is entered.

The pressing of numerical key 132 assigned a plurality of letters causes the letter A, B or C to be entered, the pressing of numerical key 133 causes the letter D, E or F to be entered, the pressing of numerical key 134 causes the letter G, H or I to be entered, the pressing of numerical key 135 causes the letter J, K or L to be entered, the pressing of numerical key 136 causes the letter M, N or O to be entered, the pressing of numerical key 137 causes the letter P, Q, R or S to be entered, the pressing of numerical key 138 causes the letter T, U or V to be entered, and the pressing of numerical key 139 causes the letter W, X, Y or Z to be entered.

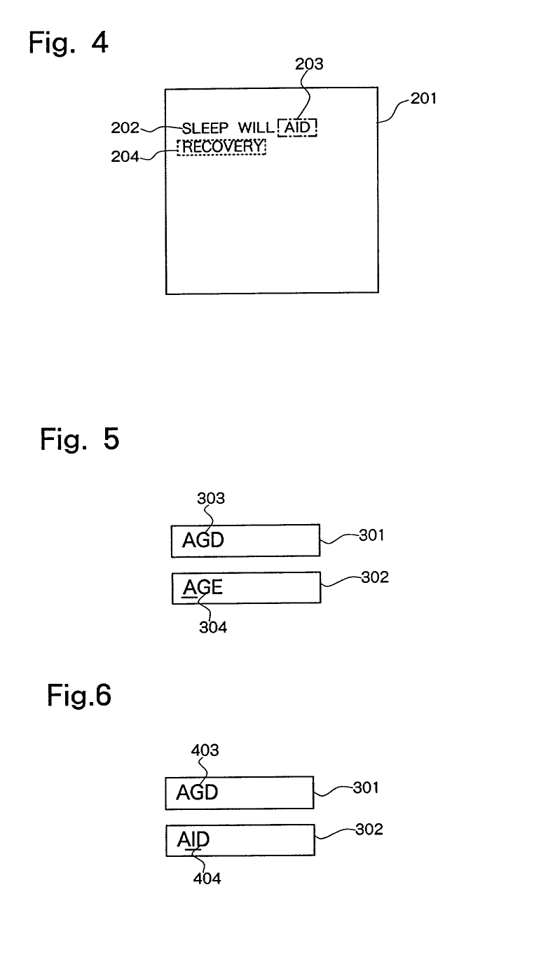

Determination of which one of a plurality of letters of the alphabet assigned to one key is entered is made as below. Assume herein that an English sentence is entered in words. FIG. 4 is a schematic view showing a display screen of the cellular phone on which a sentence is entered. FIG. 5 and FIG. 6 are schematic views showing a key entry area and a temporary entry area on the display screen.

An operator selects and presses keys of keyboard 100 on which desired letters of the alphabet are marked in accordance with the spelling of a word to be entered. Description is made, for example, for the entry of a word “AID”. The operators press numerical key 132 assigned the letters A, B, and C, numerical key 134 assigned the letters G, H, and I, and then numerical key 133 assigned the letters D, E, and F. “AGD” 303 formed of the first letters of the alphabet assigned to the respective keys is displayed in key entry area 301 on the display screen in FIG. 5. According to FIG. 2 described earlier, three possible candidates for a meaningful word are present in this case: “AGE”, “AID”, and “BID”. The first candidate “AGE” is displayed as letter string “AGE” 304 in temporary entry area 302 of the screen display in FIG. 5. Next, when the operator presses ↓key 118 assigned a next candidate selecting function, the second word candidate “AID” is displayed in temporary entry area 302. After the display is recognized, the operator presses * symbol key 140 assigned a confirming function, and then the letter string “AID” is moved to sentence entry area 201 on the display screen in FIG. 4 as letter string “AID” 203. A plurality of words 202 represent a word string whose entry has been confirmed, and word 204 surrounded by a dotted line tentatively represents a word to be entered subsequently. At the same time, the letter strings displayed in key entry area 301 and temporary entry area 302 in FIG. 5 are erased.

In a second entry method of a compatible mode, when the same word “AID” is entered, an operator presses numerical key 131 assigned only the letter A instead of numerical key 132 assigned the letters A, B, and C, presses TEL key 120 assigned only the letter I instead of numerical key 134 assigned the letters G, H, and I, and then presses numerical key 133 assigned the letters D, E, and F. In this typing, since the first letter A and the second letter I are determined, only three possible combinations of letters of the alphabet, “AID”, “AIE”, and “AIF” are candidates for the word to be entered. of these candidates, only the letter string “AID” makes sense as an English word, and the letter string “AID” is displayed in key entry area 301 in FIG. 5 and the letter string “AID” is also displayed in temporary entry area 302. After the display is recognized, the operator presses * symbol key 140. Then, the letter string “AID” is moved to and displayed in sentence entry area 201 on the display screen in FIG. 4 as letter string 203. While the aforementioned first entry method requires the operator to perform one next candidate selecting operation for determination, the second entry method requires no next candidate selection.

In this manner, the program in the CPU of the electronic device searches letter strings as shown in FIG. 2 for an intended word through comparisons with an English dictionary to efficiently enter an English sentence in words.

Next, description is made for a third entry method in the compatible mode. When the same word “AID” is entered, an operator first presses numerical key 132 assigned the letters A, B, and C, numerical key 134 assigned the letters G, H, and I, and then numerical key 133 assigned the letters D, E, and F, similarly to the first method, then letter string “AGD” 303 is displayed in key entry area 301 in FIG. 5, and letter string “AGE” 304 is displayed in temporary entry area 302 as described above. At this point, the operator can move the cursor under letter string “AGE” 304 to the right and the left with →key 116 and ←key 114. If the operator moves the cursor to the letter G of letter string 304 and presses ↑key 112, the letter G is changed to the next letter H, and if the operator presses ↑key 112 again, it is changed to the next letter I. Next, if the operator moves the cursor to the letter E of letter string 304 and presses ↓key 118, the letter E is changed to the preceding letter D. The results are displayed in FIG. 6. When the operator presses * symbol key 140 after the results are recognized, the letter string “AID” is moved to sentence entry area 201 in FIG. 4 and entered. At the same time, the displayed letters in key entry area 301 and temporary entry area 302 in FIG. 6 are erased.

Through the use of the function, the operator can enter a proper noun or a letter string other than the words stored in the dictionary surrounded by the boxes in FIG. 2.

As described above, in the compatible entry mode, the operator can enter letters of the alphabet in the same operation method as that of the prior art using only the keys on which the letters of the alphabet are assigned as conventional. However, if the operator uses additional numerical key 131 assigned only the letter A, TEL key 120 assigned only the letter I, DATA key 117 assigned only the letter U, BUZ key 119 assigned only the letter E, POW key 122 assigned only the letter O, and numerical key 141 assigned only the letter S, entry candidates are narrowed down, for example from three in FIG. 2 to one, thereby allowing increased efficiency of entry.

Next, description is made for entry of letters of the alphabet in the non-compatible mode. Since the placement of keys on a keyboard and the assignment of the letters to respective keys are the same as those of the entry of the letters in the aforementioned compatible mode, description is made centering on the difference between the non-compatible mode and the compatible mode with reference to FIG. 3 to FIG. 6.

When an operator presses numerical key 131 assigned the letter A, TEL key 120 assigned the letter I, DATA key 117 assigned the letter U, BUZ key 119 assigned the letter E, or POW key 122 assigned the letter O, the letter A, I, U, E, or O is entered. The pressing of numerical key 141 assigned the letter S causes the letter S to be entered.

The pressing of numerical key 132 causes the letter B or C to be entered, the pressing of numerical key 133 causes the letter D or F to be entered, the pressing of numerical key 134 causes the letter G or H to be entered, the pressing of numerical key 135 causes the letter J, K, or L to be entered, the pressing of numerical key 136 causes the letter M or N to be entered, the pressing of numerical key 137 causes the letter P, Q or R to be entered, the pressing of numerical key 138 causes the letter T or V to be entered, and the pressing of numerical key 139 causes the letter W, X, Y, or Z to be entered.

Determination of which one of a plurality of letters assigned to one key is entered is made as below. Assume herein that an English sentence is entered in words. An operator selects and presses keys of keyboard 100 on which letters of the alphabet are marked in accordance with the spelling of a word to be entered. However, for the letters A, I, U, E, O, and S, it is necessary to use numerical key 131, TEL key 120, DATA key 117, BUZ key 119, POW key 122, and numerical key 141 for entry, respectively.

Description is made, for example, for entry of the word “AID”. The operator presses numerical key 132 assigned the letters A, then TEL key 120 assigned the letter I, and then numerical key 133 assigned the letters D, E, and F. A letter string “AID” is displayed in key entry area 301 on the display screen in FIG. 5. Since the entry of “AI” of the letter string is determined, a possible candidate for a word in this case is only “AID” with reference to FIG. 2. Thus, the word candidate “AID” is displayed in temporary entry area 302 in the screen display in FIG. 5. When the operator presses * symbol key 140 after the display is recognized, the letter string “AID” is moved to and displayed in sentence entry area 201 on the display screen in FIG. 4 as letter string 203. At the same time, the displays of the letter string “AID” in FIG. 5 are erased.

Next, description is made for a case when an operator enters a word “BID”. The operator presses numerical key 132, TEL key 120, and then numerical key 133. A letter string “BID” which is obtained by combining the first letter B assigned to numerical key 132, the letter I assigned alone to TEL key 120, and the first letter D assigned to numerical key 133 in this order is displayed in key entry area 301 on the display screen in FIG. 5. The entry of the letter I in the letter string is determined, and in this case, as apparent from FIG. 2, possible letter strings are “BID”, “CID”, “BIF”, and “CIF”. Since only the “BID” is a possible candidate as an English word, the first letter string “BID” is displayed in temporary entry area 302. When the operator presses * symbol key 140 after the display is recognized, the letter string “BID” is moved to sentence entry area 201 on the display screen in FIG. 4. At the same time, the displays of the letter string “BID” in FIG. 5 are erased.

If “BID” is entered in a conventional manner in the compatible mode, the 27 letter strings in FIG. 2 serve as candidates for selection. As a result of a comparison with the dictionary, the letter string “AGE” is first displayed in temporary entry area 302. The operator can display the letter string “BID” by pressing the ↓key twice. Even when the letter I is entered with TEL key 120, letter strings “AID” and “BID” are candidates for a word and the letter string “AID” is first displayed in temporary entry area 302 on the display screen. Thus, the operator cannot display the letter string “BID” unless he presses the ↓key once.

In this manner, in the non-compatible mode, candidates for a word are often narrowed down to one when entry is made in words, as compared with the compatible mode. This leads to a significant improvement in efficiency when letters of the alphabet are entered.

In the non-compatible mode, the operator can also change a letter alone in the letter string displayed in temporary entry area 302 with the third entry method described earlier in the compatible mode.

A plurality of symbols can be entered in accordance with the number of successive pressings of # symbol key 142.

Large letters of the alphabet are displayed in key entry area 301 and temporary entry area 302 on the display screen for visibility and small letters of the alphabet are displayed in sentence entry area 201 on the display screen in FIG. 4 to display many sentences, thereby providing the efficient use of the overall display screen. With this configuration, since the operator accurately checks the entry of the letters of individual words in temporary entry area 302, and checks the constitution of the sentence and the general arrangement in sentence entry area 201 in FIG. 2, the small letters of the alphabet displayed in sentence entry area 201 do not produce significant inconvenience practically.

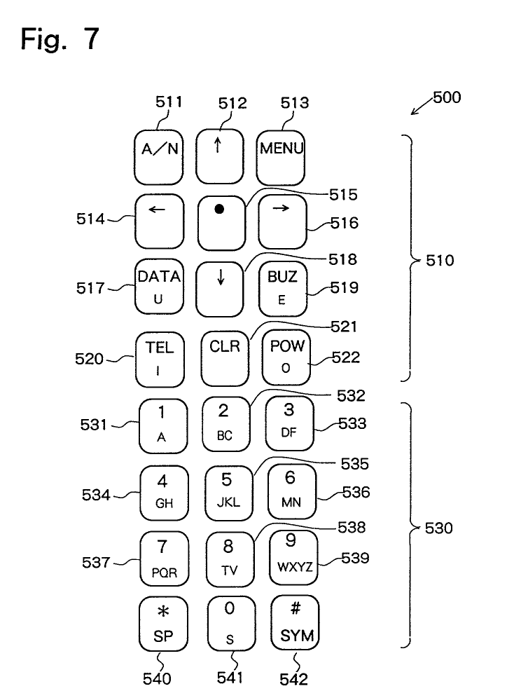

While description has been made assuming that the display of assigned letters of the alphabet on the keyboard in the non-compatible mode is the same as that of the conventional method, only the letters of the alphabet assigned actually may be displayed as shown in FIG. 7.

FIG. 3 or FIG. 7 described in the embodiment shows an example of the arrangement on the keyboard. The letter S may not be included in the particular letters depending on the conditions of allocation of the letters to the keys on the keyboard. In addition, when the number of the keys need be limited, the assignment of other particular letters may be limited although the efficiency of the entry determination is reduced.

While the embodiment has been described with a keyboard comprising physical keys, the present invention is not limited thereto. The keyboard may be any which can perform data entry and control entry, and for example, a keyboard implemented by software displayed on the screen may be used.

In addition, while the embodiment has been described with a keyboard of a cellular phone used as an example, the present invention is not limited thereto. The present invention is widely applicable to any electronic device including a keyboard, not necessarily for a cellular phone.

It is to be understood, however, that although the characteristics and advantages of the present invention have been set forth in the foregoing description, the disclosure is illustrative only, and changes may be made in the arrangement of the parts within the scope of the appended claims.

What is claimed is:

1. An electronic device comprising a keyboard including keys for entering letters of the alphabet,
wherein said keyboard comprises data keys for entering numbers, letters of the alphabet and symbols, and control keys for entering operation signals, and
each of some keys of said data keys is assigned a plurality of letters of the alphabet, each of some keys of the other data keys and some keys of said control keys is assigned only one of particular letters of the plurality of letters of the alphabet assigned to said some keys simultaneously with the assignment to said some keys.

2. The electronic device comprising a keyboard according to claim 1, wherein a plurality of letters of the alphabet are assigned to each key of said some keys of said data keys such that letters of the alphabet are regularly arranged in alphabetical order on said some keys.

3. The electronic device comprising a keyboard according to claim 1, wherein said particular letters of the alphabet are A, I, U, E, and O which are letters for vowels.

4. The electronic device comprising a keyboard according to claim 3, wherein said particular letters of the alphabet further include a letter S.

5. The electronic device comprising a keyboard according to claim 1, further comprising a word dictionary, wherein all letters of the alphabet assigned to a pressed key are candidates for entry, letter strings formed by combining all letters in pressing order are listed, all the listed letter strings are compared with words stored in said dictionary, a word matching any of the listed letter strings is extracted and serves as a candidate for a word, and an operator selects and determines for entry a desired word from the candidates for a word.

6. The electronic device comprising a keyboard according to claim 5, wherein said particular letters of the alphabet can be entered by pressing the keys assigned only said particular letters or by pressing the keys assigned said particular letters as one of the plurality of assigned letters.

7. The electronic device comprising a keyboard according to claim 5, wherein said particular letters of the alphabet can be entered only by pressing the keys assigned only said particular letters of the alphabet.

8. The electronic device comprising a keyboard according to claim 5, wherein said extracted candidate for a word is displayed in a temporary entry area on a display screen of said electronic device, and an operator selects a desired word as a determined word and moves the selected word to a sentence entry area on the display screen.

9. The electronic device comprising a keyboard according to claim 8, wherein an operator can select a letter of the alphabet in a letter string displayed in said temporary entry area through the use of a cursor key, and change the letter to another letter through a predetermined key operation to obtain a desired determined word.

10. The electronic device comprising a keyboard according to claim 8, wherein the letters of the alphabet displayed in said sentence entry area are smaller than the letters displayed in said temporary entry area.
